(19) United States
(12) Patent Application Publication
(10) Pub. No.: US 2009/0254634 A1
(43) Pub. Date: Oct. 8, 2009

(54) Method of Displaying Selected Data

(76) Inventors: Alan Scott McKinney, Fairfield, OH (US); Christopher K. Taylor, Cincinnati, OH (US); Aaron G. Weeks, Cincinnati, OH (US); Curtis A. Weeks, Loveland, OH (US)

Correspondence Address: Aaron Weeks;Apt #1, 533 Tusculum Ave, Cincinnati, OH, 45226, US

(21) Appl. No.: 12/413,523

(22) Filed: Mar. 28, 2009

Related U.S. Application Data
(60) Provisional application No. 61/041,978, filed on Apr. 3, 2008.

(51) Int. Cl. G06F 3/00; G06F 15/16

(52) U.S. Cl. 709/219; 710/67; 715/700

(57) ABSTRACT

In a first embodiment of the present invention, a method of displaying selected media is disclosed. The method comprises registering a key on a user computer; accessing a key server via the Internet when the key is pressed; and displaying selected media on the user computer. In preferred embodiments of the method, the step of registering a key on a user computer includes the step of generating and storing a unique registration code.

### RELATED APPLICATIONS

This nonprovisional application claims the benefit of the filing date of U.S. provisional patent application No. 61/041,978 entitled “Method of Displaying Selected Data” filed on Apr. 3, 2008.

### FIELD OF THE INVENTION

The present invention relates to computer functionality or action performed by pressing a computer keyboard key, more specifically, to methods for controlling the action or process performed when the key is pressed through centralized management using a server on the Internet. The present invention also relates to the use of a specialized key cap for the computer keyboard key that is pressed to perform the related action. The present invention also relates to the tracking and monitoring the use of a key on per key type code, per user, and per computer basis.

### BACKGROUND OF THE INVENTION

Computers and computer terminals are used to view video, view graphics or pictures, play audio, run applications, and access Internet web sites. Users of these devices perform these tasks by using the computer keyboard alone or in combination with other devices such as a mouse. These devices can be configured by the user to perform these actions as desired.

Computer applications also exist to allow a user to assign a keystroke to a specific operation or set of operations in order to simplify the steps needed to perform a task or action. Administrator tools exist to manage computers remotely and push software and configurations to a computer. These configurations could control the operation of certain keys. These tools are used in controlled or managed environments such as a corporation or organization and not for individual user's personal computers. U.S. Pat. No. 4,935,870 discusses control of keys from a host computer but is used in the context of a highly centralized controlled videotex system and specialized keyboards as opposed to the modern day Internet and Internet attached computers.

Prior art describes full computer keyboard overlays for water and dust protection such as described in U.S. Pat. No. 6,962,454. Also there are computer keyboard templates for entire keyboards or parts of a keyboard for use with specific applications or systems as described in U.S. Pat. No. D294706. These templates could include specialized keyboard labels with different colors, graphics, or text. Prior art also describes individual key caps in the form of a sticker as described in U.S. Pat. No. 6,883,985, in the form of a plastic mold described in U.S. Pat. No. 4,755,072, in the form of an adhesive pad described in U.S. Pat. No. 5,290,115, or in the form of a replacement key described in U.S. Pat. No. 5,391,006.

### SUMMARY OF THE INVENTION

In a first embodiment of the present invention, a method of displaying selected media is disclosed. The method comprises registering a key on a user computer; accessing a key server via the Internet when the key is pressed; and displaying selected media on the user computer. In preferred embodiments of the method, the step of registering a key on a user computer includes the step of generating and storing a unique registration code.

In some embodiments of the method the step of registering a key on a user computer further includes downloading key control application software onto the user computer; and running the key control application software on the user computer, whereby a key is selected to be utilized in the process. The key control application can be downloaded to the user computer from the Internet or from a disc.

In an alternative to the above method, the step of registering a key on a user computer further includes the step of configuring the user computer to open a web browser directed to a selected web site when a key is pressed.

In further embodiments of the method the step of registering a key on a user computer includes the steps of validating a registration code and selecting a keyboard key to associate with displaying the selected media. Furthermore, the step of generating and storing a unique registration code on the key server and storing it on the user computer. In preferred embodiments registering a key on a user computer further includes the step of attaching a key cap to the selected keyboard key.

In preferred embodiments the selected media is a web site displayed through a web browser. In highly preferred embodiments that displayed web site is a second selected media and the method further includes the step of displaying a first selected media when the key is pressed. It is preferred that the first selected media is selected from the group consisting of: a video file, an audio file, a graphic, and a computer application.

In yet another embodiment of the method the unique registration code is sent to the key server when the key is pressed and the key server tracks the pressing of the key via the unique registration code. Also, the selected media to be displayed can be controlled by the key server and it is preferred that such control be based upon the registration code.

In still further embodiments, a method of marketing is disclosed. The method includes the steps of: distributing key code information; receiving user data via the Internet from a user computer at a key server; distributing a unique registration code from the key server to the user computer; logging the pressing of a selected key on the user computer via the Internet; and instructing a user computer to display selected media when the selected key has been pressed. It is preferred that the key code information include a web site address and a key type code. Furthermore, the key code information can further include a key cover.

It is preferred that the method of marketing include the step of distributing a key control application for configuring the user computer to connect to the key server when the selected key is pressed. In such an embodiment the key control application can be distributed with the key code information. Alternatively, the key control application can be distributed via the Internet when requested by a user computer.

A key control application is installed on a computer to capture when a user selected key, such as the F5 key, is pressed. The selected key is associated with a registration code that the user was provided during a registration process. The registration code would be associated with a key type code that in turn is associated with a specific company, product, organization, service provider, or other entity. The key control application will then perform an operation or multiple operations from an instruction set and possibly media and/or application files specific to the key type code associated with the pressed key. These instructions and media and/or application files may have been included with the installation of the application or downloaded after the application was installed. Periodically, such as once a day, the key control application will check for updated instructions and media and/or application files for the configured key type code on an Internet key server, which is an accessible server on the Internet and is a term used through the description of this invention. If updated instructions or media and/or application files exist the key control application will download them to the user's computer such that when the selected key is next pressed the updated instructions and media and/or application will be used as described in the following embodiments.

In one embodiment, the user presses the selected key and the key control application starts an Internet browser application and directs the user to a web page. Whereas the specific web page that the Internet browser is directed to is not controlled by the user, but rather an Internet key server that directs the browser to a web page based on which key type code is associated with the pressed key. As an example, when the user presses the selected key, such as the F5 key, which is associated to key type code “PIZZA” that is associated with a pizza company the user's Internet browser is directed to a pizza web site with the online coupon of the day. As another example, when the user presses the selected key, such as the F5 key, which is associated to key type code “VOTE” that is associated with a certain political party, the user's Internet browser is directed to a political web site with the breaking news of the day.

In another embodiment, the user presses the selected key and the key control application plays a video file for the user to view. The video file could be of a variety of forms such as and not exclusive to MPEG, AVI, MOV (QuickTime), RM (Real Media), SWF (Macromedia Flash), and WMV (Windows Media). Optionally, when the video has completed or sometime during the video the key control application will start an Internet browser application and direct the browser to a web page that is controlled by an Internet key server. As an example, when the user presses the selected key, such as the F5 key, which is associated to key type code “VIDEOS” that is associated with a video company, the key control application may play a humorous or entertaining animated flash video and then direct the user's browser to a company web site that sells videos.

In another embodiment, the user presses the selected key and the key control application plays an audio file for the user. The audio file could be of a variety of forms such as and not exclusive to WAV, MDI, WMA, and MP3. Optionally, when the audio has completed or sometime during the audio the key control application will start an Internet browser application and direct the browser to a web page that is controlled by an Internet key server. As an example, when the user presses the selected key, such as the F5 key, which is associated to key type code “SERVE” that is associated with a service company, the key control application may play a company jingle or recorded slogan and then direct the user's browser to the company's web site. As an another example, when the user presses the selected key the key control application may play a clip from the song of the day and direct the user's browser to a music company web site.

In another embodiment, the user presses the selected key and the key control application displays a graphic or picture or set of graphics and/or pictures for the user to view. The graphic or picture file could be of a variety of forms such as and not exclusive to JPG, GIF, and BMP. Optionally, after a period of time of displaying the graphics or pictures, or at the same time the key control application will start an Internet browser application and direct the user's browser to a web page that is controlled by an Internet key server.

In another embodiment, the user presses the selected key and the key control application starts another application. Optionally, after a period of time of starting the other application or at the same time the key is pressed the key control application will start an Internet browser application and direct the browser to a web page that is controlled by an Internet key server. As an example, when the user presses the selected key the key control application may start a financial application and direct the user's browser to a web page displaying the top stock picks of the day.

In the embodiments described previously the key control application, based on its instruction set, may start an Internet browser application and direct the browser to a web page when the selected key is pressed. This may be the only operation performed or may be perform in combination with or after other operations as described in previous embodiments. The key control application will send parameters to the Internet key server which is a server accessible on the Internet. The parameters include the key type code or another identifier that can be used to lookup the key type code that is associated with the key that is pressed. The key type code describes the type of key being pressed. For example, a music site may be assigned the key type code “MUSIC”, a sports franchise may be assigned a key type code “DUNK”, and an Internet search engine site may be assigned the key type code “SEARCH”. The Internet key server will perform a lookup of the key type code in a database and then direct the user's browser to the configured web page address for the specified key type code. By using this methodology an administrator of the Internet key server using an administration console application can set the web page address associated with the key type code at anytime. As an example, at 8:00 AM, the Internet key server is configured to direct users who press a key associated with key type code “DUNK” to a web page showing a picture and news article of a basketball player dunking a basketball in a recent game. At 10:00 AM, an administrator changes the web page address associated with the key type code to a web page with a breaking news article about a coaching change, and so any user who presses a key associated with that key type code after 10 AM would be directed to this web page. Additionally, an administrator may pre-configure a scheduled date and time for the web page address associated with the key type code to be effective. For example, an administrator may configure the Internet key server to direct all users who press a key associated with key type code “BUY” after a specified date to a planned special offer web page.

In the embodiments described previously, a key control application, based on its instruction set, may play a media or set of media files such as a video or audio file, display a graphic or picture file, or start another application. An administrator of the Internet key server using an administration console application may change the instruction set and/or set of media files such that on the next key press the operation may perform a different action then previously and may play a different set of media, such as a different audio file. To support this, the key control application must periodically check the Internet key server; perhaps once per day or more often, for instruction set and media file updates. Additionally, the administrator may set a pre-configure date in the future when an instruction set or media file will change. The key control application can then download future instruction sets and media files such that the operation desired can be performed on the desired date.

In the embodiments described previously, the user may to choose to temporarily disable the action to be performed by the key control application when the selected key is pressed. To disable the action the user can press a suppression key before the selected action key. The suppression key is a configurable key for the key control application to monitor. If the key control application detects that the suppression key was pressed before the selected action key then the action normally to be performed by the key control application will not be performed. As an example, the F5 key is selected as the action key, and the Ctrl key is selected as the suppression key. If the user were to press the Ctrl key and then the F5 key the key control application would not perform the action associated with the F5 key.

In the embodiments described previously, an enabler key could be used to activate the selected key. The enabler key is a configurable key for the key control application to monitor. If the key control application detects that the enabler key was pressed and then followed by the selected key the key control application will perform the associated action. As an example, the F5 key is selected as the action key, and the Ctrl key is selected as the enabler key. If the user were to press the Ctrl key and then the F5 key the key control application would perform the action associated with the F5 key. However, if the user were to press the F5 key without preceding it by the Ctrl key then the key control application would not perform the action. This embodiment and that of the previous embodiment describing the suppression key cannot be used together.

As an additional embodiment, through a registration process a user enters a provided key type code into a key control application that runs on the user's computer or into a web page running on an Internet server. After which the user is prompted for personal and identifying information including, but not exclusive to, name and email address, and then is assigned a unique user identifier. Also the user is then assigned a unique registration code. In combination with these steps a unique PC (personal computer) identifier is generated by the key control application. The registration code, user identifier, key type code, and PC identifier are all saved and linked together in a database on an Internet key server. When a user presses the selected key the key control application will immediately send a message to the Internet key server to log the usage of the key. Information sent to the Internet key server will identify the key type code, registration code, user identifier, and PC identifier associated with the key that is pressed. The Internet key server validates the information and then updates statistics in a database on the use of the key. This usage information is then available for reporting purposes. This information is also available for billing on a per use basis for each user identifier, key type code, PC identifier, and registration code. For example, the company whose content is being played or web site the user is being directed to by the key control application could pay the vendor who provides the key control application and Internet key server an agreed upon amount for each time a user presses the key.

As an additional embodiment, an administrator through an administration console on the Internet key server may disable or deactivate the action performed by a key per key type code, per user, per PC, or per registration code. Such that when the user presses the selected key an action would no longer be performed by the key control application.

As an additional embodiment, the key control application will utilize a different set of media or application files based on user personal preferences or demographics. Also if the key control application starts an Internet browser the web site that the user is directed to by the Internet key server can be based on user personal preferences or demographics that are looked up at the time of the action. As an example, if the user entered their birth date during the registration process the Internet server would direct the user's browser to a web site that is appropriate for the user's age when the key is pressed.

The following embodiments of this invention use methods that do not require a separately installed key control application on the user's computer. These methods only support the key action where the user's Internet browser is directed to a web site address that is controlled by an Internet key server. Additionally these embodiments do not involved storing media and/or application files to the user's computer that are used by a key control application, however, the web site the user is directed to could include video, audio, or graphics as content. Additionally, the previous embodiments describing the use of suppression or enabler key do not apply.

In one embodiment, through a registration process a user enters a provided key type code into a web page running on an Internet server. After which the user is prompted for personal and identifying information including, but not exclusive to, name and email address, and then is assigned a unique user identifier. Also the user is then assigned a unique registration code. The registration code, user identifier, and key type code are all saved and linked together in a database on an Internet key server. In this embodiment the key control application is not a separate application, but rather functionality of the computer's operating system to link a selected key to an Internet web site. After the registration process the user is provided a web site address with parameters. The user is then instructed to configure the operating system to link the usage of a selected key to start an Internet browser directed to the provided web address with parameters.

In another embodiment the functionality of the computer's operating system to link a selected key to an Internet web site is used. Whereas the user configures the operating system to link the usage of a selected key to start an Internet browser directed to an Internet web site. Upon initial access of the web site the user is prompted for registration information such as, but not exclusive to, name and email address. The registration information is then saved to a database and a unique registration identifier is generated and saved to an Internet browser cookie on the user's computer. Upon subsequent uses of the key the Internet browser will direct the browser to the web site but will now bypass prompts for registration information and direct the browser to the web site associated with the registration identifier that is retrieved from the previously saved Internet browser cookie.

As an additional embodiment, the Internet key server will utilize the registration code and/or user identifier that is received from either the Internet browser cookie or through web address parameters to store statistical information in a database on the use of the key. This usage information is then available for reporting purposes and/or billing purposes.

As an additional embodiment, an administrator through an administration console on the Internet key server may disable or deactivate the redirection of the user's Internet browser when a key is pressed based on the key type code, user, or registration code. Such that when the user presses the selected key an Internet browser is started and directed to the configured web page and then redirected to an error web page instead of the standard web site.

As an additional embodiment, an administrator through an administration console can change the Internet web site that a user will be directed to when the key is pressed. Also the administrator could schedule changes to the web site address in advanced.

As an additional embodiment, the user presses a key that directs their Internet browser to a web page on the Internet key server. The Internet key server performs a lookup of the registration code, which is received from either an Internet browser cookie or passed web address parameter, in a database and then directs the user to a web site based on store user's personal preferences or demographics. As an example, if the user entered their birth date during the registration process the Internet server would direct the user's browser to a web site that is appropriate for the user's age when the key is pressed.

As an addition to the embodiments described previously, a key cap in the form, but not limited to, a replacement key, a plastic mold cover, pad, or sticker in the shape of a key may be attached to the key that the user selects to perform the action. The key cap could have a logo, text, or symbol and use colors that are associated with the function of the key. The company, product, service provider, organization, or other entity sponsoring the key would likely determine what best to put on the key cap and will typically select something that represents the purpose and function of when the key is pressed. As an example, a key type code used for going to an Internet search engine web site may have the logo of the Internet search engine company on it. As another example, the key type code for music company may have the company's logo or music symbol on it.

As another additional embodiment, the user may purchase or be provided an entire computer keyboard with a specialized key or keys already included whereas the key action is controlled by an Internet server as described in the previous embodiments. This method alleviates the need for the user to replace the existing key or attached the key cap themselves.

The uses of this invention are many and some have been described as examples in the previous embodiments. The purpose of this section is to describe the likely uses of this invention such that the intention of invention itself is better understood. All of the following uses could be done without providing a key cap or the user attaching a key cap, however, it is expected that the use of a key cap will be more effective in delivering its purpose.
a. Marketing Tool: A company may give away key caps to users as a method to generate interest in the company or product being promoted or as a tool to help generate usage of the company's or product's web site. As an example, a video rental company may give a way a key cap associated with a key that when pressed will play an entertaining slogan and direct the user's Internet browser to the recommended video of the day.
b. Fund Raiser: An organization may sell key caps to users to put on their keyboards that performed a desired function in order to raise money. As an example, a school system's parent teacher association may sell key caps associated with a key type code that will direct the parents and students to a school grading system.
c. Frequently Used Web Sites: As an example, an Internet search engine company may provide a key cap to users so that they could designate a dedicated key to quickly access a search web site.
d. Access to Exclusive Content: As an example, a financial company may sell or include a key cap with an online product offering. When the key associated with the key type code is pressed the user would be given access to exclusive content not provided to users without the key.
e. Simplify Product Usage: As an example, a children's online gaming service may provide a key cap with a product package such that the key cap could be put on a selected key so that a child could quickly access the online game when the key was pressed.
f. Informational Services: As an example, an online sports news company may give away key caps to users that could be attached to a selected key in order to quickly access the sports video of the day.
g. Real Time Related Media Updates: As an example, a cooking television show may provide a key cap such that when the key is pressed the user is directed to an Internet web page with the current recipe being prepared on the television show. As another example, the a music video television show may provide a key cap such that when the key is pressed the user is directed to an Internet web page to purchase the current song being played. As another example, a news television show may provide a key cap such that when the key is pressed the user is directed to an Internet web page with additional information on the current news story.
h. Customer Login Page: As an example, a bank may provide a customer a key cap such that when the key is pressed the user is directed to an Internet web page with the customer login page.
i. Demographic Based: As an example, a weather provider may provide a key cap such that when the key is pressed the user is directed to an Internet web page with the weather for the user's specific zip code.

### BRIEF DESCRIPTION OF THE DRAWINGS

FIG. 1 is a schematic of the components for utilizing an embodiment of the present invention;

FIG. 2 is a flow diagram of the installation process of the key control application of FIG. 1 in one embodiment of the present invention;

FIG. 3 is a flow diagram of an embodiment of the registration process;

FIG. 4 is a flow diagram of an embodiment of the invention used to control the media;

FIG. 5 is a flow diagram of the process of one embodiment when a user presses a selected key;

FIG. 6 is a flow diagram of an alternative embodiment to FIG. 3;

FIG. 7 shows the key press process that is used in combination with the registration process described for FIG. 6; and

FIG. 8 is an alternative embodiment of the processes shown in FIGS. 6 and 7.

### DETAILED DESCRIPTION OF THE PREFERRED EMBODIMENTS

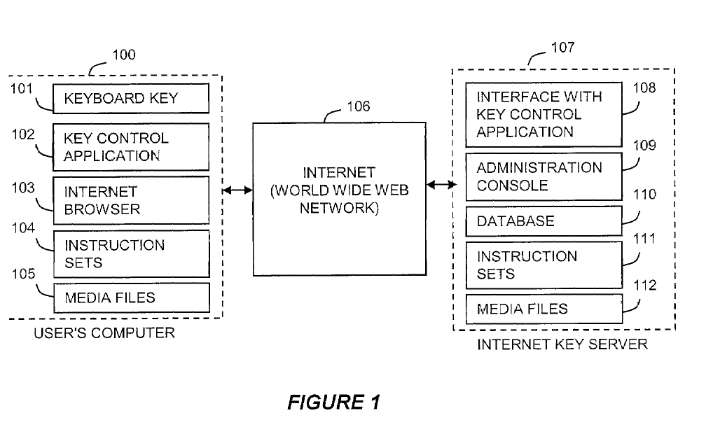

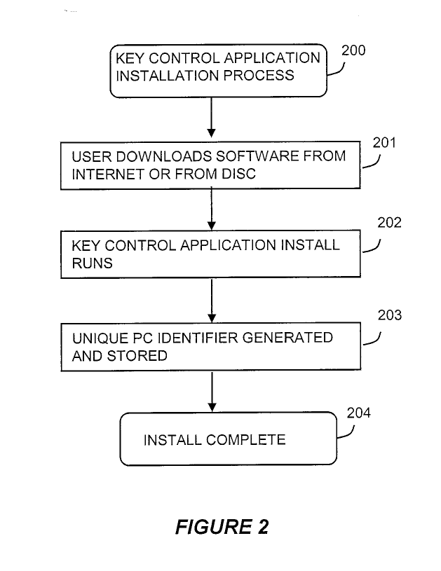

FIG. 1 shows the basic components of the system referenced in embodiments of the invention using a key control application on the user's computer. The processes and interactions involving these components are further detailed in FIGS. 2 through 5. Dashed line box 100 represents the user's computer and dashed line box 107 represents the Internet key server. Communication between the user's computer and the Internet key server occur over the Internet also commonly referred to as the World Wide Web. The user's computer 100 includes the following components:
A. 101 is the keyboard key used to initiate the action performed and may have a key cap with a logo or graphic that represents the action performed and/or the company, organization, service provider, or other entity associated with the key.
B. 102 is the key control application that is installed on the user's computer. It monitors for the key being pressed and interacts with the Internet key server 107 over the Internet 106. The key control application reads the instruction set and initiates the playing of the media files 105 and/or starts an Internet browser 103 to direct the user's browser to a web site.
C. 103 is the Internet browser that may used in the action performed when the key is pressed. The Internet browser may also be used in the key registration process.
D. 104 is a copy of the instruction set that is stored on the user's computer and used by the key control application 102 to determine the action to be performed.
E. 105 is a copy of the media files which may consist of video, audio, graphics, pictures, or application files that are used by the key control application when the key is pressed.

Dashed line box 107 represents the Internet server referred to as the Internet key server and contains the following:
A. 108 is the interface component of the Internet key server that communicates with the key control application in the registration, media update, and key action processes.
B. 109 is an administration console that is used to configure and control the actions performed when the key is pressed on the users' computers.
C. 110 is the database that stores user, key, PC, registration, and key action information. It also stores statistic data on the usage of the keys.
D. 111 is the master copy of the instruction sets for the key actions. These instruction sets are retrieved by the key control application when updates are needed.
E. 112 is the master copy of the media files for the key actions. These files are retrieved by the key control application when updates are needed.

FIG. 2 shows a flow diagram for the installation process 200 of the key control application. In step 201 the user goes to a web site to download the installation software or receives a disc containing the installation software. In step 202 the user runs the installation software to install the key control application to their computer. In step 203 the installation software or the first time run of the key control application generates a unique PC identifier such as in the form of a Microsoft's GUID (Global Unique IDentifier) that is permanently associated with the computer. The PC identifier is stored to the computer's local storage for later referral. Step 204 completes the installation process.

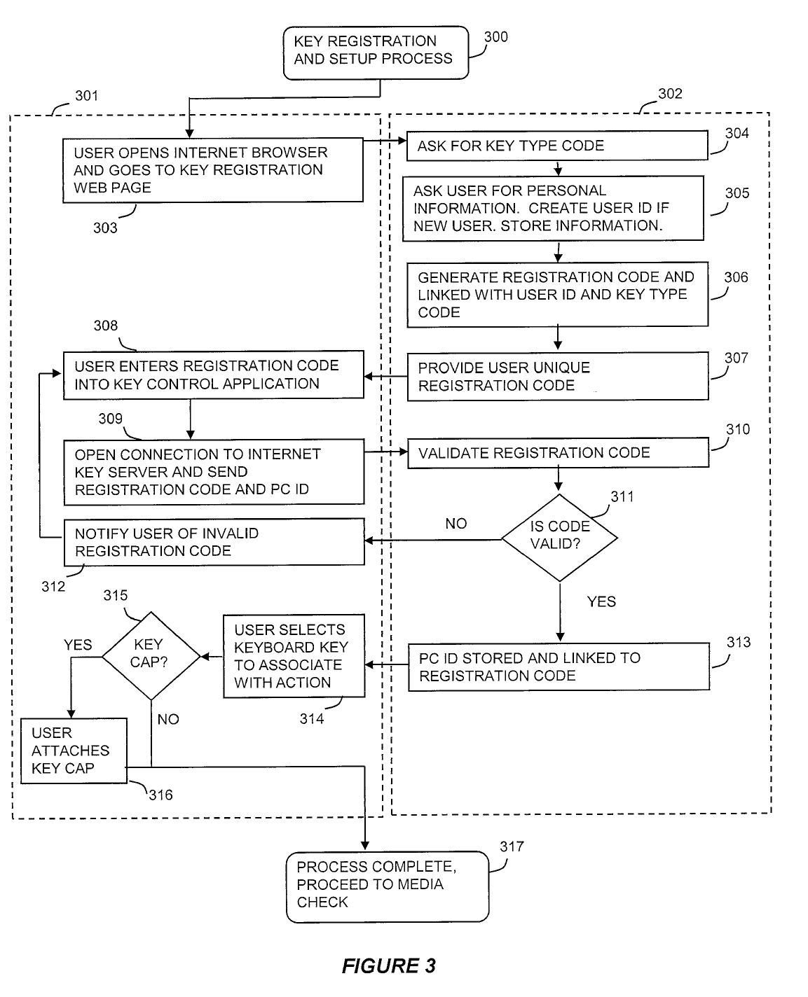

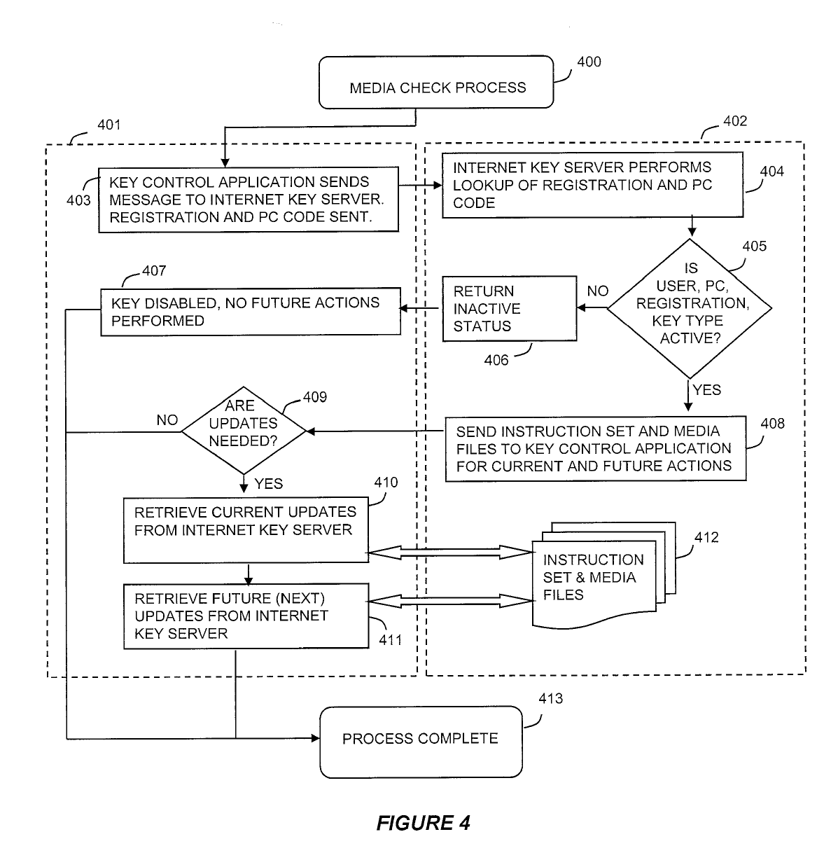

FIG. 3 shows the key registration and setup process 300. Steps shown in the dashed line box 301 take place on the user's computer. Steps shown in the dashed line box 302 take place on an Internet server described within the embodiments as the Internet key server. In step 303 the user starts an Internet browser and goes to a key registration web page. In step 304 the user is prompted for a key type code. The key type code identifies the type of key and can be a unique combination of alpha and numeric characters. For example, a key type code used for an Internet search engine company may be “SEARCH”. The user may receive this key type code in a variety of ways such as on a card, brochure, email message, or web site page with or without a key cap from the company, service provider, organization, or other entity that is providing the content received or displayed when the user presses the key. As an alternative the user could be directed to a web page specific for the key type code, thus bypassing the need to enter a key type code. Next the user may be prompted in 305 for personal information. Personal information may include a variety of attributes such as name, birth date, address, phone number, and email address. A unique user identifier is generated and this information is then saved to a database for later reference. If the user had previously registered then a new user identifier would not be generated. If desired, step 305 may be skipped but would not allow tracking of key usage by specific user as described in one embodiment. Alternatively steps 304 and 305 could be performed by the key control application in communication with the Internet key server instead of through interaction with a web page. In step 306 a unique registration code is generated and associated with the user's user identifier if determined in step 305. The registration code is linked to the user identifier and key type code in the database. In step 307 the user is provided a unique registration code either immediately or in an email message. In step 308 the user enters the registration code into the key control application on the user's computer. This step assumes that the software installation process for the key control application described in FIG. 2 has been performed. In step 309 the key control application sends the registration code with the PC identifier to the Internet key server. The Internet key server receives the message from the user's computer in 310. If in 311 the registration code that the user entered is not valid a message is sent to the key control application in step 312 and the user is notified that an error occurred. A registration code may be invalid if it was not previously generated or if the registration code is already associated with a PC identifier that is different then the one sent from the key control application. This check insures that users do not share registration codes with one another, which would impact the ability of the system to accurately track usage per user and per PC. If the registration code is valid in 311, the PC identifier is stored and linked to the registration code in the Internet key server database in 313. Also the Internet key server notifies the key control application of the successful validation in 313. The key control application in 314 prompts the user to select the key on the computer's keyboard that should be associated with the key type code. For example, the user may select the F5 key to associate to the key type code. In 315, if the user has a key cap for the key type code then the user can attached it to the selected key in step 316. 317 completes the key registration process, but before the key is ready to be used the instruction set and any media files, such as video, audio, graphics, pictures, and application files must be downloaded. This process is described in FIG. 4

FIG. 4 shows the media check and download process. Process 400 allows for the Internet key server to control the instruction set and content displayed by the key control application when the selected key is pressed by the user. The term media in this context refers to any files such as video, audio, graphics, pictures, or application files that are used by the key control application when the user presses the key. This process is performed at the end of the key registration and setup process described in FIG. 3. This process is also performed periodically on a once per day or more frequent schedule to insure the instruction set and media files are up to date. Steps shown in the dashed line box 401 take place on the user's computer. Steps shown in the dashed line box 402 take place on an Internet server described within the embodiments as the Internet key server. In step 403 the key control application sends a message to the Internet key server that includes the unique registration code and the unique PC code that are acquired in processes described in FIG. 2 and FIG. 3. In step 404 the Internet key server looks up the received registration code in a database. The Internet key server verifies that the PC code, registration code, associated user identifier, and key type code are active in 405. One of these entities may have been deactivated through an administration console on the Internet key server in order to disable key usage on a per key type code, per user, per PC, or per registration code basis. If one of these entities is not active a status message 406 is returned to the key control application on the user's computer. In step 407 the key is disabled such that the key control application will no longer perform any action when the key is pressed by the user. In this scenario the media check process ends with 413. If the key type code, user identifier, PC identifier, and registration code are active the Internet key server will send the instruction set and media version, as well as download information in step 408 to the key control application about the current and future actions to be performed when the key is pressed. In step 409, the key control application will compare the instruction set and media files stored on the user's computer with what the Internet key server has specified. If the locally stored instruction set and media files are current then the media check process ends with 413. If the locally stored instruction set and media files are not the same or do not exist then the key control application will retrieve the updated instruction set and media files from the Internet key server. Both the current and future instruction set and media files are stored on the user's computer. The current instruction set and media files are what the key control application will use when the user presses a key at the present time. The future (next) instruction set and media files are what the key control application is to use at some point in the future. The time at which this future instruction set becomes the current instruction set is specified within the instruction set. In step 410 the key control application retrieves the current instruction set and media files 412 from the Internet key server. In step 411 the key control application retrieves the future instruction set and media files 412 from the Internet key server. Some key actions may not include any media files, such as in the case where the action to be performed when the selected key is pressed is to start an Internet browser and direct the browser to a web site. In these cases only an updated instruction set would be downloaded in steps 410 and 411. Once the download has been completed the media check and download process is complete.

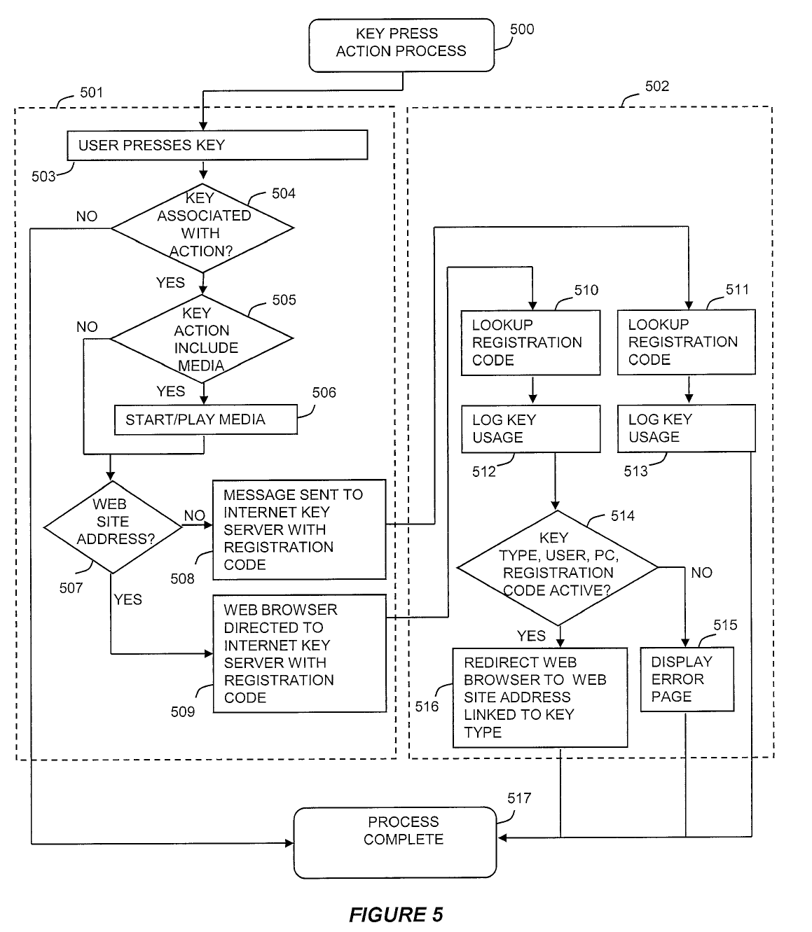

FIG. 5 shows the key press action process. This process 500 is performed when the user presses the selected key. The key control application must be running on the user's computer in order to monitor keyboard activity for key or keys configured to perform actions. Steps shown in the dashed line box 501 take place on the user's computer. Steps shown in the dashed line box 502 take place on an Internet server described within embodiments as the Internet key server. The user pressing the selected key starts the process. In step 504 the key control application checks to see if the key that was pressed is a selected action key. As described in one embodiment step 504 also includes verifying that a configured suppression key was not pressed by the user before the action key. If the suppression key was pressed immediately before the action key then no action will be performed and the process completes at 517. As described in another embodiment step 504 may include a check for an enabler key instead of a suppression key. If the enabler key is not pressed immediately before the action key then no action will be performed and the process completes at 517. If the pressed key is a configured action key, the key control application checks the instruction set for the key to determine if the key action includes locally stored media files and associated actions. Media files can be video, audio, graphics, pictures, or other application files. If media files do exist the key control application will play them in step 506 as described in the embodiments of this invention. The definition of “play” depends on the context of the type of media file or files. Video files will be played back to the user through the computer's monitor and speakers. Audio files will be played back to the user through the computer's speakers. Graphic files will be displayed to the user. Application files will be executed. In step 507, if the instruction set for the key action does not include a web site action the key control application will send a message with the registration code to the Internet key server in step 508. In step 511 the Internet key server performs a lookup of the registration code in a database. In step 513 the usage of the key is logged to the database such that statistics can be used for reporting and/or billing purposes. In step 507, if the instruction set for the key action does includes a web site action the key control application starts an Internet browser application. In step 509 the Internet browser application is directed to a web page on the Internet key server. The web site address includes the associated registration code as a parameter. In step 510 the Internet key server performs a lookup of the registration code in a database. In step 512 the usage of the key is logged to the database such that statistics can be used for reporting and/or billing purposes. Since the registration code is linked to a user identifier, PC identifier, and key type code usage statistics are tracked for all of these entities. The Internet key server will verify in step 514 that the user identifier, PC identifier, key type code, and registration code are active. One of these entities may have been deactivated through an administration console on the Internet key server in order to disable key usage a per key type code, per user, per PC, or per registration code. If one of these entities is not active the Internet browser will be directed to an error web page in step 515 after which the process is completed at 517. If all of these entities are active in 514 then the Internet key server in step 516 will direct the user's Internet browser to the web page site associated with key type code linked to the registration code, after which the process is completed at 517.

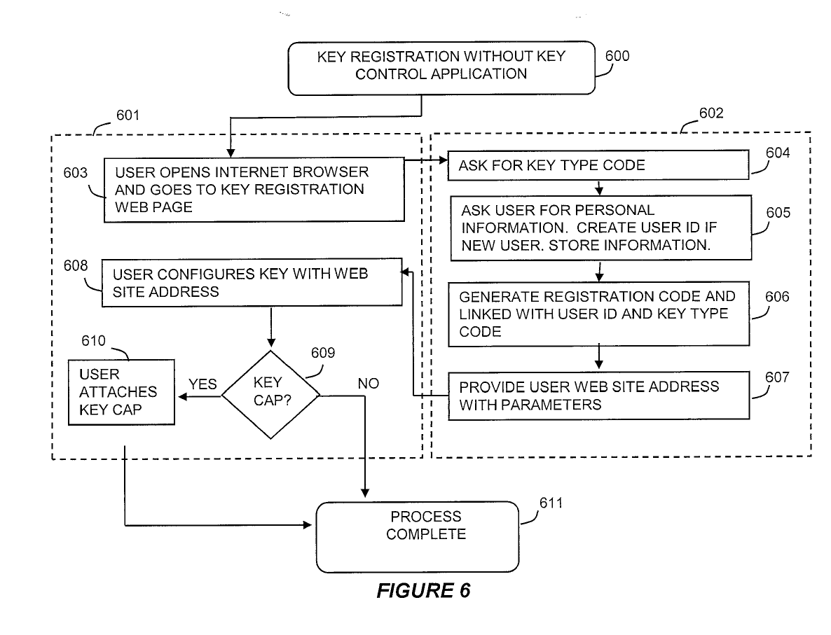

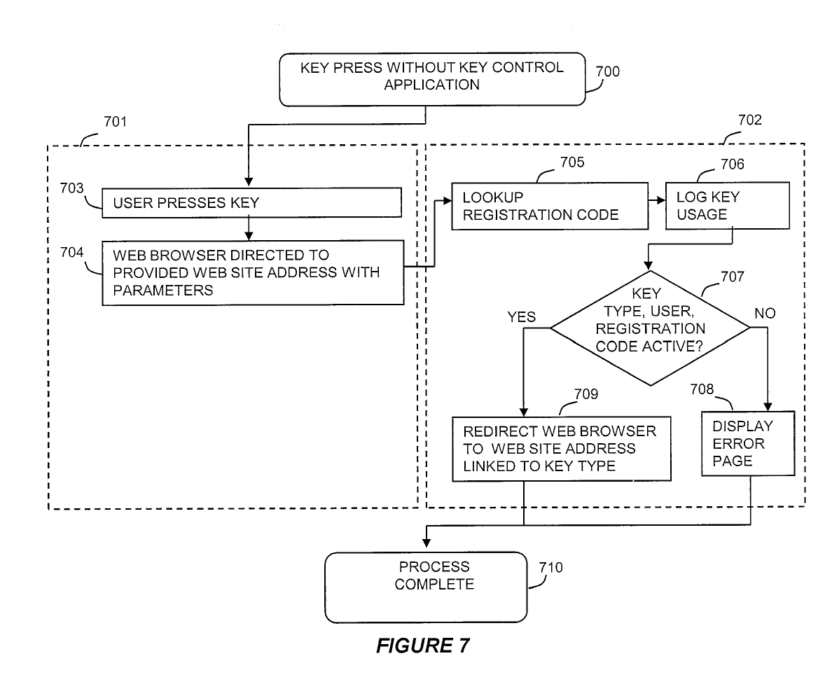

FIG. 6 shows the registration process 600 for an embodiment that does not utilize a separate key control application. Steps shown in the dashed line box 601 take place on the user's computer. Steps shown in the dashed line box 602 take place on an Internet server described within embodiments as the Internet key server. In step 603 the user starts an Internet browser and goes to a key registration web page. In step 604 the user is prompted for a key type code. The key type code identifies the type of key and can be a unique combination of alpha and numeric characters. For example, a key type code used for an Internet search engine company may be “SEARCH”. The user may receive this key type code in a variety of ways such as on a card, brochure, email message, or web site page with or without a key cap from the company, service provider, organization, or other entity that is providing the content received or displayed when the user will press the key. As an alternative the user could be directed to a web page specific for the key type code, thus bypassing the need to enter a key type code. Next the user may be prompted in 605 for personal information. Personal information may include a variety of attributes such as name, birth date, address, phone number, and email address. A unique user identifier is generated and this information is then saved to a database for later reference. If the user had previously registered then a new user identifier would not be generated. If desired, step 605 may be skipped but would not allow tracking of key usage by specific user as described in one embodiment. In step 606 a unique registration code is generated and associated with the user's user identifier if determined in step 605. The registration code is linked to the user identifier and key type code in the database. In step 607 the user is provided a web site address with parameters that included the registration code, such as www.keyserver.com?code=1234567. In step 608, the user must then configure the computer's operating system to start an Internet browser to the provided web site address including parameters when the selected key is pressed. Instructions would be provided to the user since most users would not be familiar with this process. For example, Microsoft Windows users would follow these steps: 1) right click the mouse button on the Windows Desktop and select New→Shortcut, 2) when prompted type, or copy and paste the specified web site address and press Next, 3) enter a description for the shortcut and press Finish, 5) select the new shortcut icon with the mouse and press the right mouse button and select Properties, 6) go to the “Shortcut key” setting and press the desired keyboard key that will activate the shortcut, 7) press OK to complete the process. If in step 609 if the user has an associated key cap they can attach the key cap to the selected key in step 610. This completes the process at 611 and the key is ready to be used as described in the process detailed in FIG. 7.

FIG. 7 shows the key press action process without the use of a key control application. This process 700 is performed when the user presses the selected key. The key must be configured in the computer's operating system to launch an Internet browser with a pre-configured web site address as described in FIG. 6. Steps shown in the dashed line box 701 take place on the user's computer. Steps shown in the dashed line box 702 take place on an Internet server described within embodiments as the Internet key server. The user pressing the selected key starts the process. In step 704 the computer's operating system starts the Internet browser directing the user to the pre-configured web site address with parameters. In step 705 the Internet key server performs a lookup of the registration code in a database. In step 706 the usage of the key is logged to the database such that statistics can be used for reporting and/or billing purposes. Since the registration code is linked to a user identifier and key type code usage statistics are tracked for all of these entities. The Internet key server will verify in step 707 that the user identifier, key type code, and registration code are active. One of these entities may have been deactivated through an administration console on the Internet key server in order to disable key usage a per key type code, per user, or per registration code. If one of these entities is not active the Internet browser will be directed to an error web page in step 708 after which the process is completed at 710. If all of these entities are active in 707 then the Internet key server in step 709 will direct the user's Internet browser to the web page site associated with key type code linked to the registration code, after which the process is completed at 710.

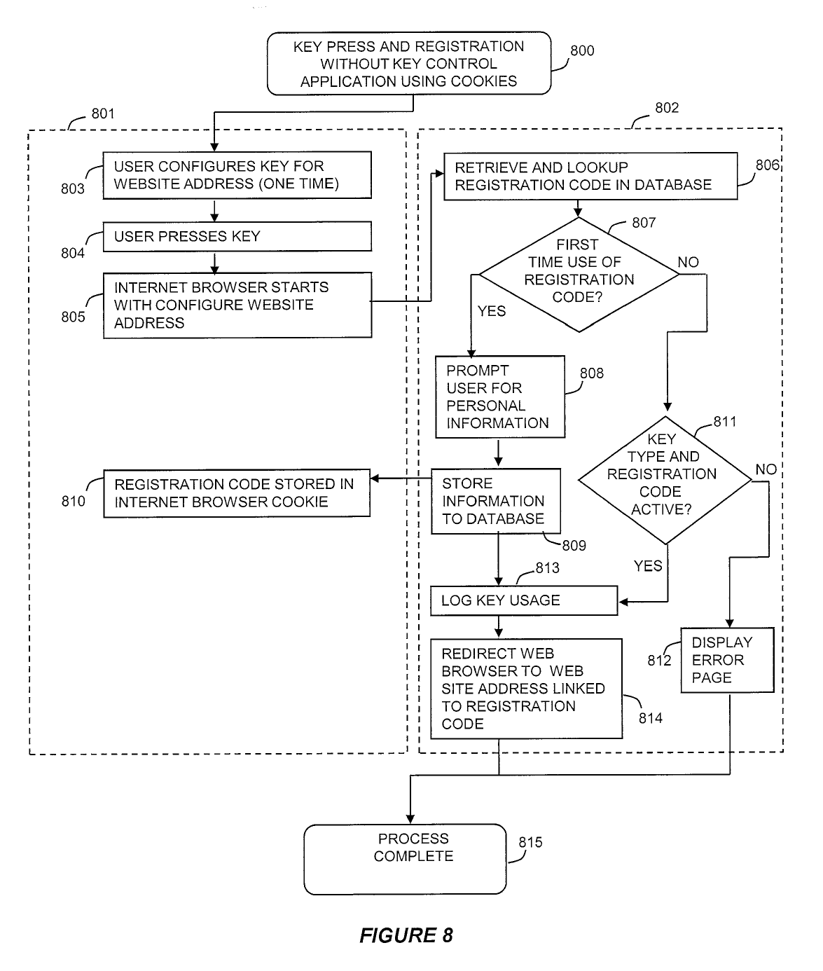

FIG. 8 shows an alternative approach to the registration and key press methods described in FIGS. 6 and 7. Like the methods described in FIGS. 7 and 8 a separate key control application is not used as described in FIGS. 1 through 5. Steps shown in the dashed line box 801 take place on the user's computer. Steps shown in the dashed line box 802 take place on an Internet server described within embodiments as the Internet key server. In step 803 the user is instructed to use the functionality of the computer's operating system to configure a key to launch an Internet browser with a pre-configured web site address. The user may have received this web site address in a variety of ways such as on a card, brochure, email message, or web site page with or without a key cap from the company, service provider, organization, or other entity that is providing the content received or displayed when the user will press the key. In step 804 the user presses the selected key and the computer's operating system starts the Internet browser in 805 directing the user to the pre-configured web site address. In step 806, the Internet key server retrieves registration and/or user identifying information from a previously stored browser cookie. A cookie is information that a web site puts on the user's hard disk so that it can be recalled at a later time. If there is no previously stored registration or user information in 807, the Internet key server will prompt the user for personal information in step 808. Personal information may include a variety of attributes such as name, birth date, address, phone number, and email address. A unique user identifier is generated and this information is then saved to a database for later reference. If the user had previously registered then a new user identifier would not be generated. If desired, step 808 may be skipped but would not allow tracking of key usage by specific user as described in one embodiment. In step 809 a unique registration code is generated and associated with the user's user identifier if determined in step 808. The registration code is linked to the user identifier and key type code in the database. In step 810 the registration and/or user identifier is stored in a cookie on the user's computer. In step 813 the Internet key server will log the usage of the key and redirect the user's Internet browser to the web site associated with the registration code. In step 807, if the user had previously registered and the Internet key server is able to retrieve the registration or user identifying information from the user's Internet browser cookie then the Internet key server will move on to step 811. In this step the Internet key server will use a database to verify that the registration code and associated key type code and user identifier are active. If any of these entities had been previously deactivated by an administrator the user's Internet browser will be directed to an error page in step 812. If these entities are active the Internet key server will log usage statistics into a database for purposes of reporting and/or billing. In step 814 the user's Internet browser will be directed to the web site address associated with the registration code. This completes the process in 815.

While the principles of the invention have been shown and described in connection with specific embodiments, it is to be understood that such embodiments are by way of example and are not limiting.

1. A method of displaying selected media, the method comprising the steps of:
registering a key on a user computer;
accessing a key server via the Internet when the key is pressed; and
displaying selected media on the user computer.

2. The method of claim 1 wherein the step of registering a key on a user computer includes the step of generating and storing a unique registration code.

3. The method of claim 2 wherein the step of registering a key on a user computer further includes the steps of:
downloading key control application software onto the user computer; and
running the key control application software on the user computer, whereby a key is selected to be utilized in the process.

4. The method of claim 3 wherein the key control application is downloaded to the user computer from the Internet.

5. The method of claim 3 wherein the key control application is downloaded to the user computer from a disc.

6. The method of claim 2 wherein the step of registering a key on a user computer further includes the step of configuring the user computer to open a web browser directed to a selected web site when a key is pressed.

7. The method of claim 2 wherein the step of generating and storing a unique registration occurs at the key sever with data sent from the user computer and wherein the step of registering a key on a user computer further includes the steps of:
validating a registration code; and
selecting a keyboard key to associate with displaying the selected media.

8. The method of claim 7 wherein the step of registering a key on a user computer further includes the step of attaching a key cap to the selected keyboard key.

9. The method of claim 7 wherein the selected media is a web site displayed through a web browser.

10. The method of claim 9 where the displayed web site is a second selected media, the method further including the step of displaying a first selected media when the key is pressed.

11. The method of claim 10 wherein the first selected media is selected from the group consisting of: a web site, a video file, an audio file, a graphic, and a computer application.

12. The method of claim 2 wherein the unique registration code is sent to the key server when the key is pressed and the key server tracks the pressing of the key via the unique registration code.

13. The method of claim 12 wherein the selected media to be displayed is controlled by the key server.

14. The method of claim 13 wherein the key server controls the selected media based upon the unique registration code.

15. A method of marketing, comprising the steps of:
distributing key code information;
receiving user data via the Internet from a user computer at a key server;
distributing a unique registration code from the key server to the user computer;
logging the pressing of a selected key on the user computer via the Internet; and
instructing a user computer to display selected media when the selected key has been pressed.

16. The method of claim 15 wherein the key code information includes a web site address and a key type code.

17. The method of claim 16 wherein the key code information further includes a key cover.

18. The method of claim 15 further including the step of distributing a key control application for configuring the user computer to connect to the key server when the selected key is pressed.

19. The method of claim 18 where the key control application is distributed with the key code information.

20. Them method of claim 18 wherein the key control application is distributed via the Internet when requested by a user computer.
